(19) United States
(12) Patent Application Publication
(10) Pub. No.: US 2004/0179439 A1
(43) Pub. Date: Sep. 16, 2004

(54) METHOD FOR PROCESSING ERROR CONTROL FOR A SEEKING SERVO OF AN OPTICAL DISK DRIVE

(76) Inventors: Jen-Yu Hsu, Taipei City (TW); Hsiang-Yi Fu, Taipei City (TW); Tun-Chieh Lee, Taipei City (TW); Fu-Hsiang Chen, Taipei City (TW); Yao-Chou Tsai, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,008

(22) Filed: Sep. 1, 2003

(30) Foreign Application Priority Data
Apr. 10, 2003 (TW) 092108325
Dec. 10, 2002 (TW) 091135751

(51) Int. Cl. G11B 7/00

(52) U.S. Cl. 369/44.28

(57) ABSTRACT

A method for processing error control for a seeking servo of an optical disk drive includes calculating a “track on” time when control of a pickup head is switched from a seeking servo system to a tracking servo system to start a “track on” process, moving the pickup head to the center of a movable range when the “rack on” process is not completed in a predetermined time, and switching control of the pickup head to the tracking servo system to start another “track on” process.

### BACKGROUND OF INVENTION

1. Field of the Invention

The present invention relates to a method for controlling a seeking servo of an optical disk drive, and more specifically, to a method for processing error control for a seeking servo of an optical disk drive.

2. Description of the Prior Art

Optical disks are storage media required to support rapid random access. In order to fulfill this requirement, an optical disk drive must move a sledge to a target position with a seeking servo in the most rapid manner and then the operation of “track on” begins (i.e. position a pickup head)with a tracking servo. However, although required to be rapid and precise, it is inevitable that the pickup head will be out of focus or over-vibrated. Thus even the sledge reaches the target position, the operation of “tracking on” the target position cannot be precisely executed.

For instance, please refer to FIG. 1 showing a conventional sledge and a process to track on the target position (i.e. position a pickup head). Generally, when an optical disk drive is in long seek process, a seeking servo system controls the sledge 26 to move to a target position where a tracking servo system positions the pickup head 24. A movable range 27 on the sledge 26 provides a range of positions for the pickup head 24 during a “track on”, follow or short seek process. Generally, if the pickup head is not being controlled,it will stay in the center of the movable range 27. In FIG. 1, when the sledge 26 moves to the target position, the tracking servo system controls the pickup head to “track on” a target track 23 on an optical disk 22.

The switchover between the seeking servo and the tracking servo is controlled by a control chip in the optical disk drive, and the control chip includes a tracking signal. The control chip calculates the number of tracks passed over by the sledge driven by the seeking servo system, and switches to the tracking servo system when the sledge reaches to the target position in order to “track on” a target track 23.

Please refer to FIG. 2 and FIG. 3 showing a conventional sledge and a “track on” process of a pickup head. When the sledge 26, controlled by the seeking servo system, stops over or before the target position, the pickup head 24, controlled by the tracking servo system, can move in the movable range 27 to track on the target track 23 on the optical disk 22.

However, when the pickup head 24 “tracks on” a position on the disk near the boundary of the movable range 27, it is possible that the pickup head 24 could drag the sledge 26 causing a displacement of the sledge 26. Furthermore, as the pickup head 24 follows the movement of the sledge 26, the “track on” process will fail and the pickup head 24 will vibrate unstably. There are, of course, various possible situationsthat can cause failures in the “track on” process, however,for the purpose of brevity, only one of the situationsis mentioned above.

Please refer to FIG. 4 showing waveforms of the corresponding signals in the “track on” process of the pickup head 24 according to the prior art. As shown in FIG. 4, under the control of the seeking servo system, the tracking error signal represents the number of tracks that the pickup head 24 has passed over. When the pickup head 24 passes over one track, the tracking error signal will pass a zero cross point 52 and become a sine wave, as output by the seeking servo system. Therefore, the number of tracks passed over by the pickup head 24 can be determined by counting the peak values.Thus the sledge 26 arrives at the target position, the servo system switches to the tracking servo system and begin the ‘track on’ process.

When the “track on” process starts, the tracking error signal is output by the tracking servo system. In this situation the tracking error signal represents the tracking status of the pickup head 24.

In addition, the tracking control voltage signal represents the control force on the pickup head 24. When the tracking control voltage signal is on the zero cross point 54, the pickup head 24 is not forced at all; whilepositive and negative voltages represent two opposite directions of force respectively.

As shown in FIG. 4, at time point 56, the sledge 26 arrives at the target position. At the same time, the control chip in the optical disk drive will generate a “On Track” signal (not shown). Therefore, the switchover from the seeking servo system to the tracking servo system can be seen by the tracking error signal, and additionally, the pickup head has completedthe “track on” process when the tracking error signal and the tracking control voltage signal become stable.

At time point 57, the pickup head 24 starts another long seek process, and at time point 58, the sledge 26 arrives at the target position and the output of the tracking error signal is switched from the seeking servo system to the tracking servo system. At the same time, the tracking control voltage signal shows an unstable oscillation, which represents that the pickup head 24 is also vibrating. As shown by the tracking error signal, the tracking servo system cannot stabilize the pickup head 24 and, therefore, after time point 58 the “track on” process fails.

Moreover, the center error signal can also be adopted to determine the position of the pickup head 24. The center error signal is aposition signal of the pickup head 24.

When the center error signal is on the zero cross point 54, the pickup head 24 is at the center of the movable range 27.

As shown in FIG. 7, at time point 80, the sledge 26 arrives at the target position. At the same time, the control chip in the optical disk drive will generate a “On Track” signal (not shown). Therefore, the switchover from the seeking servo system to the tracking servo system can be seen by the tracking error signal, and additionally, the pickup head has completedthe “track on” process when the tracking error signal and the tracking control voltage signal become stable.

At time point 82, the pickup head 24 starts another long seek process, and at time point 84, the sledge 26 arrives at the target position and the output of the tracking error signal is switched from the seeking servo system to the tracking servo system. At the same time, the center error signal shows an particular negative amplitude, which means that the pickup head 24 is away from the center of the movable range 27. As shown by the tracking error signal, the tracking servo system cannot stabilize the pickup head 24 and, therefore, after time point 84 the “track on” process fails.

In the prior art, when the “track on” process fails, the pickup head 24 vibrates unstably and the seeking servo system triesthe “track on” process again. In this condition, the “track on” process will take a long time. As shown in FIG. 4 and FIG. 7, the “track on” process succeeds at time point 62 after a long time duration (t). If the tracking servo system is not well designed, it is possible that the pickup head 24 will be unable to track on the target track, thus causinga read delay or failure.

### SUMMARY OF INVENTION

It is therefore a primary objective of the present invention to provide a method that interrupts the “rack on” process after it fails, movesthe pickup head back to the center of the movable range, and then switches to the tracking servo system to start another “track on” process.

Briefly summarized, a method for processing error control for a seeking servo of an optical disk drive includes calculating a “track on” time when the control of a pickup head is switched from a seeking servo system to a tracking servo system to start a “track on” process, moving the pickup head to the center of a movable range when the “track on” process exceeds a predetermined time, and switching the control of the pickup head to the tracking servo system to start another “track on” process.

According to the present invention, a method for processing error control for a seeking servo of an optical disk drive includes detecting a center error signal starting when the control of a pickup head is switched from a seeking servo system to a tracking servo system to start a “track on” process, moving the pickup head to the center of a movable range when the center error signal exceeds a predetermined value, and switching the control of the pickup head to the tracking servo system to start another “track on” process.These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1, FIG. 2 and FIG. 3 illustrate a conventional sledge and a “track on” process of a pickup head according to the prior art.

FIG. 4 illustrates waveforms of corresponding signals in the “rack on” process of the pickup head according to the prior art.

FIG. 5 illustrates waveforms of corresponding signals in the t“ack on” process of the pickup head according to the present invention.

FIG. 6 illustrates a procedure of processing error control of the seeking servo system according to the present invention.

FIG. 7 illustrates waveforms of corresponding signals in the t“rack on” process of the pickup head according to the prior art.

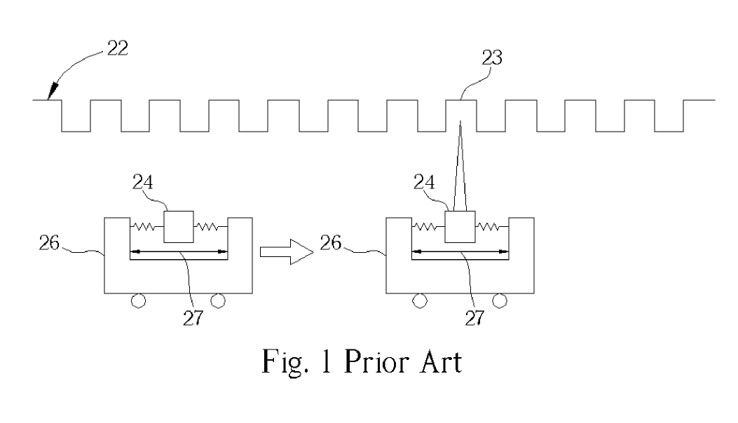

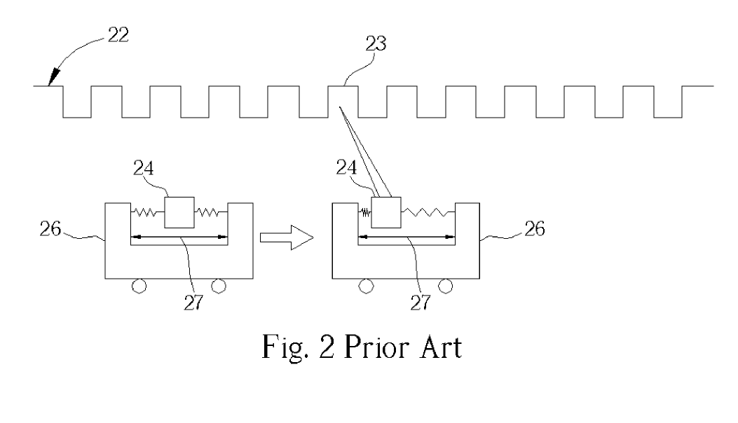

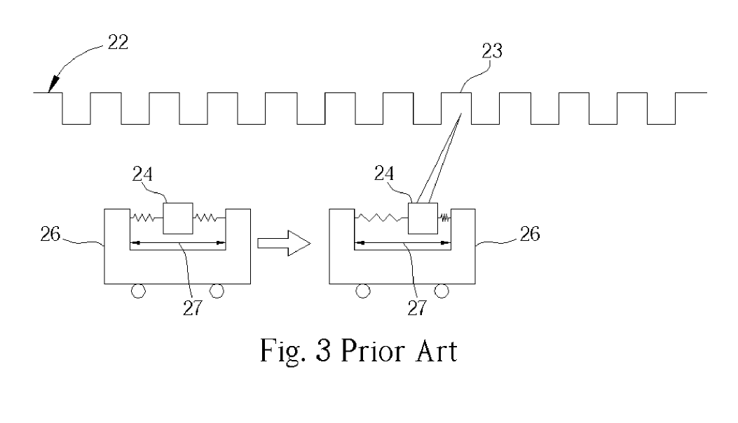

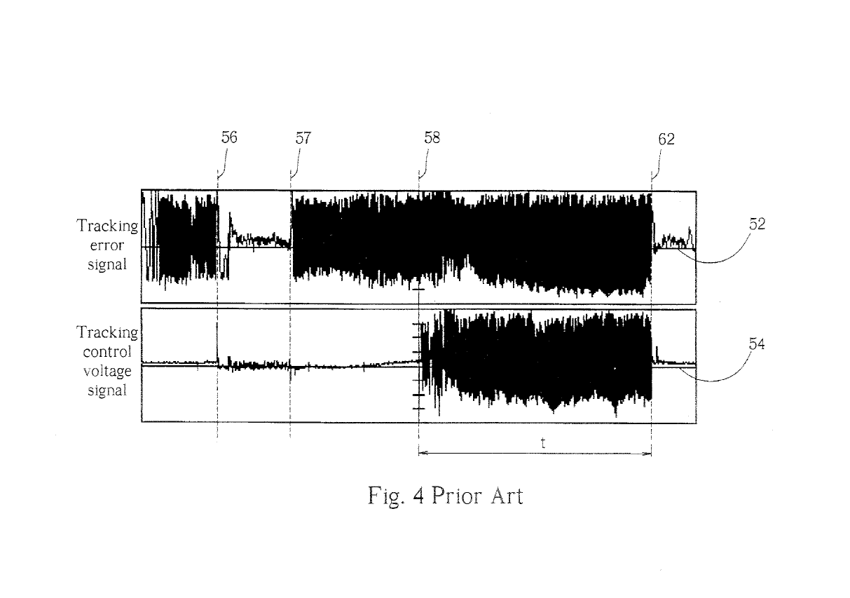

### DETAILED DESCRIPTION

The present invention provides a method to improve the disadvantages of the prior art such as long time consumption and failure while “tracking ona” s mentioned above. In the present invention, a t“rack on” time is calculated when t“rack on” process starts. Generally, it takes a very short time, approximately a few microseconds (μs), for a pickup head to track on. A t“rack on” failure can be detected when the t“rack on” time is over a predetermined time. The predetermined time is 3 milliseconds (ms) according to the present invention. Therefore, when the t“rack on” time is over 3 ms, the t“rack on” process is interrupted and the pickup head will be stabilized. The calculation of the t“rack on” time is determined by measuring the duration of a O“n Track” signal, which means that the t“rack on” time is calculated when the O“n Track” signal is on.

Moreover,“track on” failure can be also determined by a center error signal. The center error signal is a signal representing the position of the pickup head in a movable range. When the center error signal is on the zero cross point, the pickup head is at the center of the movable range. Therefore, when the control on the pickup head is switched to a tracking servo system, i.e. in the “track on” process, the center error deviates from the zero cross point such that the deviation is over a predetermined value and the “track on” process fails.

When the “track on” process fails, the pickup head vibrates. In this situation, a center servo control system moves the pickup head to the center of the movable range. If no center servo control system exists in the optical disk drive, the pickup head is released and then it will move uncontrolled back to the center. This is because when uncontrolled, the pickup head oscillatesat a natural frequency until the natural damping reduces the oscillation and the pickup head returns to the center.

When the pickup head becomes stable, control is switched to the tracking servo system. Since the seeking servo system has already moved the sledge to the target position, the re-“track on” process will be completed in a short time.

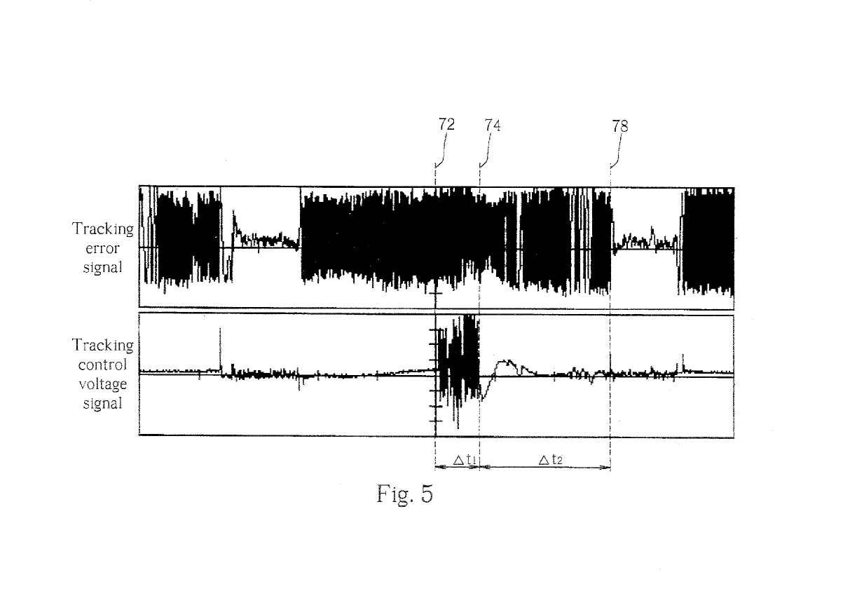

As shown in FIG. 5, at time point 72, the sledge arrives at the target position. At the same time, the “On Track” signal is on, the seeking servo system is switched to the tracking servo system, and the “track on” time calculation is started. In this situation, the tracking error signal and the tracking control voltage signal oscillate, which means that the pickup head also vibrates.ln other words, the tracking servo system cannot stabilize the pickup head and the “track on” process fails. When the “track on” time is over the predetermined time (Δt1), the tracking process is interrupted; in FIG. 5, the “track on” process is interrupted at time point 74.

Between time point 74 and time point 78 (the total time is Δt2), the pickup head returns to the center of the movable range. The movement is by the center servo control system or by the oscillation of the pickup head in natural frequency until natural damping reduces the oscillation so that the pickup head moves to the center.

At time point 78, the pickup head arrives at the center of the movable range, and control is switched to the tracking servo system to starta re-“track on” process. The re-“track on” process will be completed in a short time.

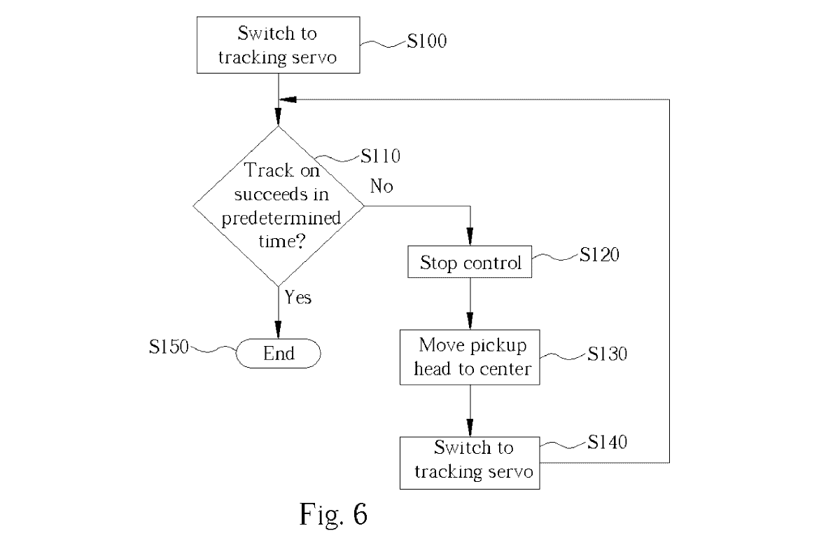

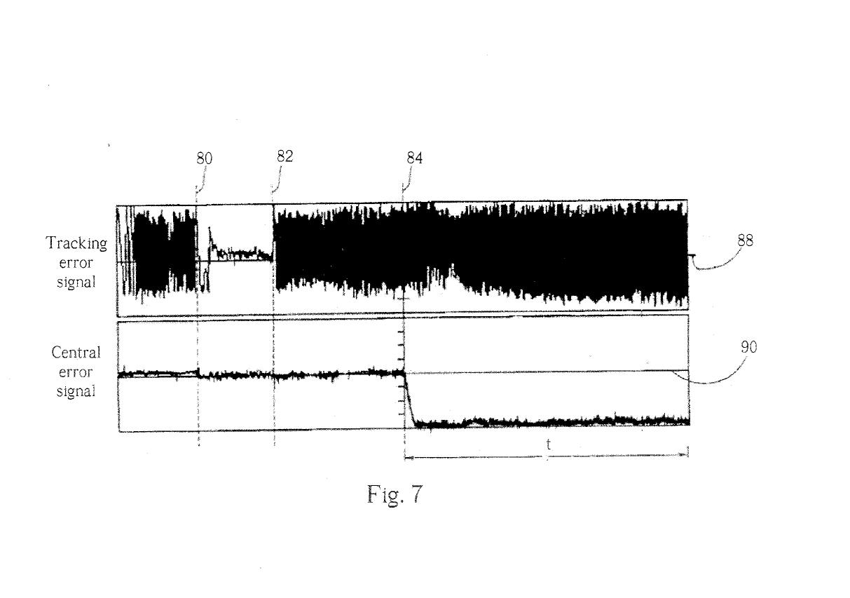

Please refer to FIG. 6 showing a flow of processing error control of the seeking servo system according to the present invention.

S100 Switch the control of the pickup head from the seeking servo system to the tracking servo system;

S110 Monitor whether the “track on” process succeeds in the predetermined time. If yes, proceed to step S150, if no, proceed to step S120.

S120 Stop control of the pickup head by the tracking servo system;

S130Move the pickup head to the center of the movable range;

S140Switch control of the pickup head to the tracking servo system;

S150End.

Accordingly, the method of processing error control of the tracking servo system of the optical disk device is to start calculating a “track on” time when the “track on” process starts. When the “track on” time exceeds the predetermined time, the process is interrupted. Next, activate the center servo control system or let the pickup head oscillate atits natural frequency to have the pickup head move to the center of the movable range. Finally, switch control to the tracking servo system for another “track on” process.

In contrast to the prior art, the method according to the present invention involves interrupting the “track on” process after it fails, and moving the pickup head to the center of the movable range. In such a manner, the method according to the present invention reduces the time for the tracking servo system to control the pickup head after the “track on” process fails. Furthermore, the method increases the efficiency of the optical disk drive while reading data as unnecessarily wastedtime is reduced and the reading/writing success rate is increased.

Those skilled in the art will readily observe that numerous modifications and alterations of the method. Accordingly, the above disclosure should be construed as limited only by the metes and bounds of the appended claims.

What is claimed is:

1. A method for processing error control for a seeking servo of an optical disk drive comprising following steps:
calculating a “track on” time when the control of a pickup head is switched from a seeking servo system to a tracking servo system;
moving the pickup head to the center of a movable range when the “track on” process is not completed in a predetermined time; and
switching control of the pickup head to the tracking servo system.

2. The method according to claim 1, when control of the pickup head is switched from the seeking servo system to the tracking servo system is determined by a “On Track” signal.

3. The method of claim 1 wherein a center servo control system is provided to move the pickup head to the center of the movable range.

4. The method of claim 1 wherein the pickup head oscillates at a natural frequency and moves to the center of the movable range by natural damping.

5. A method for processing error control for a seeking servo of an optical disk drive comprising following steps:
detecting a center error signal when control of a pickup head is switched from a seeking servo system to a tracking servo system;
moving the pickup head to the center of a movable range when the center error signal exceeds a predetermined value; and
switching control of the pickup head to the tracking servo system.

6. The method according to claim 5, when control of the pickup head is switched from the seeking servo system to the tracking servo system is determined by a “On Track” signal.

7. The method of claim 5 wherein a center servo control system is provided to move the pickup head to the center of the movable range.

8. The method of claim 5 wherein the pickup head oscillates at a natural frequency and moves to the center of the movable range by natural damping.
